(19) United States
(12) Patent Application Publication
(10) Pub. No.: US 2014/0182637 A1
(43) Pub. Date: Jul. 3, 2014

(54) SNOW REMOVING APPARATUS FOR A VEHICLE

(71) Applicant: Sung Jung Kim, Gwangju (KR)

(72) Inventor: Sung Jung Kim, Gwangju (KR)

(73) Assignee: GWANGJU NAMGU OFFICE, Gwangju (KR)

(21) Appl. No.: 14/236,683

(22) PCT Filed: Aug. 13, 2012
(86) PCT No.: PCT/KR2012/006432

§ 371 Date: Feb. 3, 2014

(30) Foreign Application Priority Data
Aug. 12, 2011 (KR) 10-2011-0080791
Sep. 2, 2011 (KR) 10-2011-0089153

(51) Int. Cl. B60S 3/04

(52) U.S. Cl. CPC B60S 3/04
USPC 134/123

(57) ABSTRACT

The present invention relates to a snow removing apparatus for a vehicle, comprising a frame installed on a vehicle; a first spraying portion installed on the frame for spraying a snow remover in a downward direction; a second spraying portion installed on at least one side surface from among both side surfaces of the frame, for spraying a snow remover in a lateral direction to the frame; a snow remover supplying portion for supplying the snow remover to the first and second spraying portions; and a control unit for controlling the sprayed state of the snow remover from the first and second spraying portions. The snow removing apparatus for a vehicle according to the present invention has a lateral spraying nozzle capable of spraying a snow remover in a lateral direction to a snow removing vehicle, and has the advantage of being able to expand the spraying range of the snow remover. Also, when another vehicle or a person approaches the snow removing vehicle, the other vehicle or the person is detected, and the spraying from the lateral spraying nozzle is stopped, in order to prevent the exterior of the other vehicle or the clothing worn by the person from being corroded by the snow remover.

### TECHNICAL FIELD

The present invention relates to a snow removing apparatus for a vehicle, and more particularly, to a snow removing apparatus for a vehicle, which performs a snow removing operation on an ice-bound or snow covered road in winter season.

### BACKGROUND ART

In winter season, road freezing due to drifted snow and ice causes skidding of a vehicle and is a main factor of traffic accidents.

As a conventional road freezing measure, there is a method of sprinkling sands on a road through human agency or spraying calcium chloride on the road using snow removing equipment such as a snow removing vehicle

A vehicle having a snow removing apparatus used in removing snow on the road includes a snow bucket disposed at a front side of a vehicle body so as to remove the snow, a calcium chloride sprayer disposed at a rear side of the vehicle body, and a calcium chloride tank disposed at an upper side of the vehicle body so as to store calcium chloride.

However, in the conventional vehicle having the snow removing apparatus, it is difficult to remove ice firmly frozen on the road using the snow bucket, and thus it is difficult to perform its own function in a snow removing operation on the road on which snow is frozen.

Korean Patent Publication No. 10-2005-0019249 discloses a spraying device of snow-removing-liquid for a car.

The spraying device of snow-removing-liquid for the car includes a storage tank which stores the snow-removing-liquid in which calcium chloride or salt is dissolved, a discharge pipe which discharges the snow-removing-liquid in the storage tank, and an air supply unit which compresses air and selectively supplies the compressed air to the storage tank through an air supply pipe, or to the discharge pipe through an air compressing pipe.

However, the spraying device of snow-removing-liquid for the car does not include a heating means for heating the snow-removing-liquid stored in the storage tank, and thus the low temperature snow-removing-liquid is sprayed on the frozen road. Therefore, snow removal efficiency thereof is deteriorated. Further, since the snow-removing-liquid is sprayed through the fixed discharge, a spraying range of the snow-removing-liquid is limited.

### DISCLOSURE OF THE INVENTION

In order to overcome the above-mentioned shortcomings, the present invention provides a snow removing apparatus for a vehicle, which has a side spraying nozzle capable of spraying a deicing agent at a lateral side of the vehicle and thus increasing a spraying range of the deicing agent.

According to an aspect of the invention, there is provided a snow removing apparatus for a vehicle including a frame installed at the vehicle, a first spraying part installed at the frame so as to spray a deicing agent downwardly, a second spraying part installed at at least one of both side surface of the frame so as to spray the deicing agent to a lateral side of the frame, a deicing agent supply part supplying the deicing agent to the first and second spraying parts, and a control unit controlling a deicing agent spraying state of the first and second spraying parts.

The control unit may include a detecting sensor installed at the frame adjacent to the second spraying part so as to detect other vehicles or persons approaching a spraying range of the second spraying part, and a control part stopping a spraying operation of the deicing agent from the second spraying part when the other vehicles or persons are detected by the detecting sensor.

The control unit may further include a speed sensor for the vehicle so as to detect a speed of the vehicle, and the control part may stop the spraying operation of the deicing agent through the first and second spraying parts when a stopped state of the vehicle is detected by the speed sensor.

The second spraying part may include a rotational member which is installed at one of both side surfaces of the frame so as to be rotated up and down; at least one lateral spraying nozzle fixed to the rotational member so as to receive the deicing agent from the deicing agent supply part and to spray the deicing agent to a later side of the frame, and a driving member rotating the rotational member up and down.

According to another aspect of the invention, there is provided a snow removing apparatus for a vehicle further including a deicing agent heating part heating the deicing agent flowing to the first and second spraying parts.

The snow removing apparatus for the vehicle may further include a crushing part installed at the frame so as to be spaced apart to the front and rear sides with respect to the first spraying part based on a vehicle movement direction and thus to crush ice frozen on a road; and a third spraying part spraying the deicing agent to the road when the crushing part crushes the ice.

The crushing part may include a crushing roller of which both ends are rotatably installed at the frame, a plurality of crushing blades which are formed on an outer circumferential surface of the crushing roller so as to protrude in a direction away from the crushing roller, and a roller driving part which rotates the crushing roller.

The third spraying part may include a chamber provided in the crushing roller so as to store the deicing agent, a plurality of spraying holes formed in the outer circumferential surface of the crushing roller so as to be communicated with the chamber, an injection passage formed to be communicated from a rotational shaft of the crushing roller into the chamber, and a rotary joint rotatably installed at the rotational shaft of the crushing roller so as to supply the deicing agent to the chamber, and the deicing agent supply part may supply the deicing agent to the chamber through the rotary joint.

As described above, since the snow removing apparatus for the vehicle according to the present invention has the side spraying nozzle capable of spraying deicing agent at the lateral side of the vehicle, it is possible to increase the spraying range of the deicing agent.

Further, when other vehicles or persons approach the vehicle for the snow removing operation, the spraying of the lateral spraying nozzles is stopped, and thus it is possible to prevent exteriors of the other vehicles or clothes of the persons from being corroded by the deicing agent.

### BRIEF DESCRIPTION OF THE DRAWINGS

The objects, features and advantages of the present invention will be more apparent from the following detailed description in conjunction with the accompanying drawings, in which:

FIG. 1 is a perspective view of a snow removing apparatus for a vehicle according to one embodiment of the present invention;

FIG. 2 is a perspective view of a second spraying part of a snow removing apparatus for a vehicle according to another embodiment of the present invention;

FIG. 3 is a perspective view of a snow removing apparatus for a vehicle according to still another embodiment of the present invention;

FIG. 4 is a cross-sectional view of a deicing agent heating part of the snow removing apparatus for the vehicle of FIG. 3;

FIG. 5 is a perspective view of a second spraying part of a snow removing apparatus for a vehicle according to yet still another embodiment of the present invention;

FIG. 6 is a perspective view of a snow removing apparatus for a vehicle according to yet still another embodiment of the present invention;

FIG. 7 is a perspective view of a snow removing apparatus for a vehicle according to yet still another embodiment of the present invention; and

FIG. 8 is a cross-sectional view of a crushing roller of the snow removing apparatus for the vehicle of FIG. 7.

### BEST MODE FOR CARRYING OUT THE INVENTION

Hereinafter, embodiments of the present invention will be described in detail with reference to the accompanying drawings.

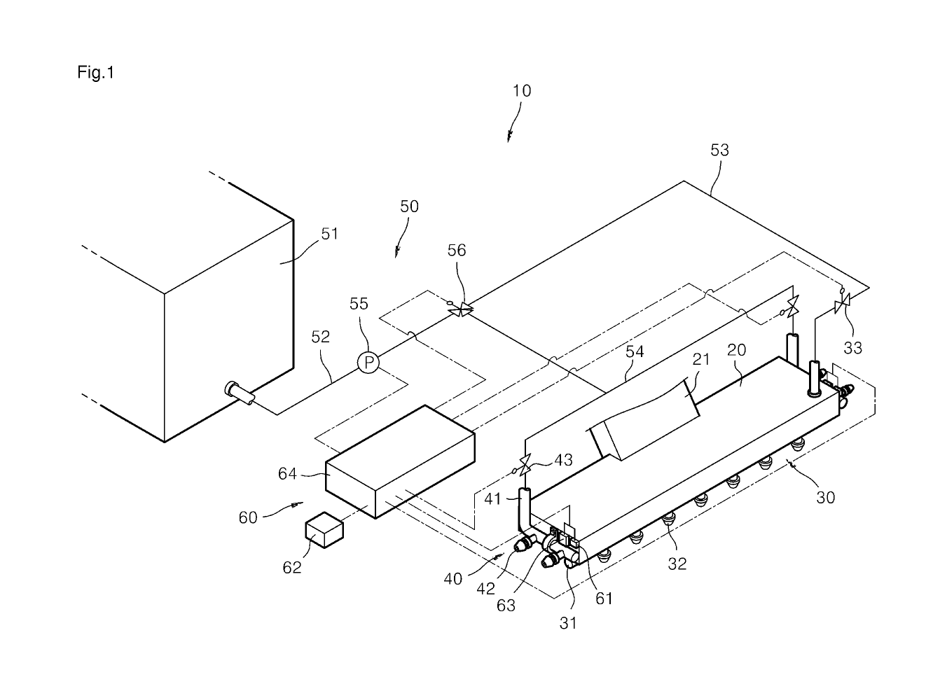

FIG. 1 is a perspective view of a snow removing apparatus 10 for a vehicle according to one embodiment of the present invention.

Referring to the drawing, the snow removing apparatus 10 for the vehicle includes a frame 20 which is installed in the vehicle, a first spraying part 30 which is installed at the frame 20 so as to spray a deicing agent downwardly, a second spraying part 40 which is installed at both side surfaces of the frame 20 so as to spray the deicing agent to a lateral side of the frame 20, a deicing agent supply part 50 which supplies the deicing agent to the first and second spraying parts 30 and 40, and a control unit 60 which controls a deicing agent spraying state of the first and second spraying parts 30 and 40.

The frame 20 has a desired thickness and a quadrangular cross-section and is formed to be extended in a width direction of the vehicle. The frame 20 is fixed to a rear side of the vehicle through a flange member 21 installed at a front side of the vehicle in a vehicle movement direction. One end of the flange member 21 is fixed to the frame 20, and the other end thereof is extended from the frame 20 to a front side thereof and, although not shown, fixed to a rear lower surface of the vehicle through a fixing means such as a captive bolt.

Further, the frame 20 may be formed of stainless steel or a synthetic resin having a desired strength so as to prevent the frame 20 from being corroded by the deicing agent sprayed from the first and second spraying parts 30 and 40.

The first spring part 30 includes a first spraying tube 31 installed at a lower surface of the frame 20, and a plurality of downward spraying nozzles 32 installed at the first spraying tube 31.

The first spraying tube 31 has a pipe shape forming a passage through which the deicing agent flows, and is extended to be parallel with an extended direction of the frame 20. An end of the first spraying tube 31 is extended to pass through the frame 20 and to be bent upwardly, and then connected to the deicing agent supply part 50. Further, a first opening and shutting valve 33 is installed at the first spraying tube 31 so that the passage is easily opened and shut by the control unit 60.

The downward spraying nozzles 32 are respectively installed at a lower outer circumferential surface of the first spraying tube 31 in the extended direction of the frame 20 so as to be spaced apart from each other. A spraying hole (not shown) through which the deicing agent is sprayed is formed at each of the downward spraying nozzles 32 so as to be directed to a lower side of the frame 20, such that the deicing agent supplied to the first spraying tube 31 through the deicing agent supply part 50 is sprayed to a road at the lower side of the frame 20.

At this time, the deicing agent may be a deicing liquid in which calcium chloride or sodium chloride is dissolved.

The second spraying part 40 includes a plurality of second spraying tubes 41 installed at both side surfaces of the frame 20, and a plurality of lateral spraying nozzles 42 installed at the second spraying tubes 41.

Each of the second spraying tubes 41 has a pipe shape forming a passage through which the deicing agent flows, and is extended in a predetermined length in a longitudinal direction based on the vehicle movement direction. The second spraying tubes 41 are respectively fixed at the both side surface of the frame 20 by fixing brackets, and front ends of the second spraying tubes 41 may be bent upwardly to be easily connected with the deicing agent supply part 50. Further, a second opening and shutting valve 43 is installed at each of the second spraying tubes 41 so that the passage is easily opened and shut by the control unit 60.

The lateral spraying nozzles 42 are respectively installed at a later outer circumferential surface of the second spraying tube 41 in the longitudinal direction so as to be spaced apart from each other. A spraying hole (not shown) through which the deicing agent is sprayed is formed at each of the lateral spraying nozzles 42 so as to be directed to a lateral side of the frame 20, such that the deicing agent supplied to the second spraying tube 41 through the deicing agent supply part 50 is sprayed to the road at both lateral sides of the frame 20.

As described above, the deicing agent is sprayed to the later sides of the frame 20 as well as the lower side thereof through the first and the second spraying parts 30 and 40, and thus it is possible to spray the deicing agent to a wider range.

The deicing agent supply part 50 includes a storage tank 51 which stores a large amount of the deicing agent, a supply conduit part which has pipe conduits supplying the deicing agent stored in the storage tank 51 to the first and second spraying parts 30 and 40, and a supply pump 55 which is installed at the supply conduit part so as to pump and supply the deicing agent stored in the storage tank 51 to the first and second spraying parts 30 and 40.

The storage tank 51 has a storage space in which the deicing agent is stored, and is formed of stainless steel or a synthetic resin having a desired strength so as to prevent the frame 20 from being corroded by the deicing agent stored therein. Although not shown, the storage tank 51 may be installed to the vehicle.

The supply conduit part includes a discharge tube 52 connected to an outlet port of the storage tank 51, a first connection tube 53 branched from an end of the discharge tube 52 and connected with the first spraying tubes 31, and a second connection tube 54 branched from the end of the discharge tube 52 and connected with the second spraying tubes 41.

A 3-way value 56 is installed at a connection part between the first and second connection tubes 53 and 54 so that flow of the deicing agent may be easily controlled by the control unit 60.

The control unit 60 includes a detecting sensor 61 which detects other vehicles or persons approaching a spraying range of the second spraying part 40, a speed sensor 62 which is installed at the vehicle so as to detect a speed of the vehicle, a road width detecting sensor 63 which measures a distance from the lateral spraying nozzles 42 to an edge of the road, and a control part 64 which is connected with each sensor so as to control the spraying states of the first and second spraying parts 30 and 40.

The detecting sensor 61 is installed in plural at the both side surfaces of the frame 20, which is adjacent to the lateral spraying nozzles 42, so as to detect an object approaching the later sides of the frame 20.

The speed sensor 62 is connected with a speed displaying means for displaying a speed of the vehicle for the snow removing operation, detects the speed of the vehicle for the snow removing operation, and thus determines whether the vehicle is in a moving state or a stopping state.

The road width detecting sensor 63 is installed in plural at the both side surfaces of the frame 20 adjacent to the lateral spraying nozzles 42. The road width detecting sensor 63 serves to measure a distance between the both side surfaces of the frame 20 and the both edges of the road using ultrasonic waves. Here, the ultrasonic waves are generated from the both side surfaces of the frame 20 to a lateral direction thereof and calculates the distance based on a time period that the ultrasonic waves are reflected and returned by the edges of the road, a boundary stone or a median strip.

The control part 64 is connected with the supply pump 55, the first and second opening and shutting valves 33 and 43 and the 3-way valve 56, and controls the supply pump 55 and each of the valves based on information measured through the detecting sensor 61, the speed sensor 62 and the road width detecting sensor 63.

If the persons or the vehicles approaching the spraying range of the lateral spraying nozzles 42 are detected by the detecting sensor 61, the control part 64 operates the second opening and shutting valve 43 and shuts second spraying tubes 41, thereby preventing the deicing agent from being sprayed from the lateral spraying nozzles 42. When the persons or other vehicles approach the vehicle for the snow removing operation, the control part 64 detects the vehicles or the persons and stops spraying of the lateral spraying nozzles 42, and thus it is possible to prevent exteriors of the other vehicles or clothes of the persons from being corroded by the deicing agent.

Further, if the speed sensor 62 detects the stopped state of the vehicle, the control part 64 stops an operation of the supply pump 55, operates the first and second opening and shutting valves 33 and 43, and thus shuts the first and second spraying tubes 31 and 41 in order to stop the spraying of the deicing agent through the first and second spraying parts 30 and 40. When the vehicle for the snow removing operation is stopped, the control part 64 stops the spraying of the deicing agent, and thus the deicing agent is sprayed only when the vehicle is moved, and it is possible to save the deicing agent.

The control part 64 controls the supply pump 55 based on distance information from the side surfaces of the frame 20 to the edges of the road, which is obtained by the road width detecting sensor 63, and thus controls a spraying pressure of the deicing agent sprayed through the lateral spraying nozzles 42. When the distances from the side surface of the frame 20 to the edge of the road becomes wider than initial distance, the control part 64 controls the supply pump 55 so as to increase the spraying pressure of the lateral spraying nozzles 42, such that the deicing agent may be sprayed over a wider range. Meanwhile, when the distance from the side surface of the frame 20 to the edge of the road becomes narrower, the control part 64 controls the supply pump 55 so as to reduce the spraying pressure of the lateral spraying nozzles 42, such that the deicing agent is prevented from being sprayed to a sidewalk.

Meanwhile, in the illustrated embodiment, the supply pump 55 is controlled in order to adjust the spraying pressure of the lateral spraying nozzles 42. However, the control unit 60 is not limited thereto, and a regulating means for controlling a size of a nozzle hole in each of the lateral spraying nozzles 42 may be provided in order to adjust the spraying pressure of the lateral spraying nozzles 42.

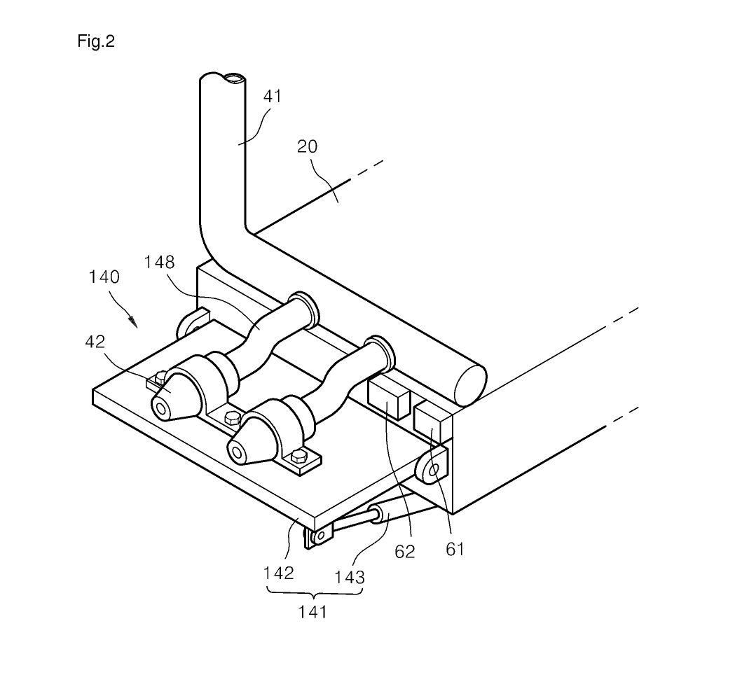

Meanwhile, FIG. 2 is a perspective view of a second spraying part 140 according to another embodiment of the present invention.

The same reference numerals are given to the parts which are the same as or correspond to those in the previous embodiment.

Referring to the drawing, the second spraying part 140 further includes a rotational unit 141 which rotates the lateral spraying nozzles 42 up and down.

The rotational unit 141 is installed at the both side surfaces of the frame 20 so as to be rotated up and down, and includes a rotational member 142 having an upper surface on which the lateral spraying nozzles 42 are installed, and a driving member 143 which rotates the rotational member 142 up and down.

At this time, the second spraying tubes 41 are respectively installed at both side ends of an upper surface of the frame 20, and a connection tube formed of a flexible material is installed between each of the second spraying tubes 41 and each of the lateral spraying nozzles 42.

The rotational member 142 is formed into a plate shape having a predetermined thickness. One end of the rotational member 142 is installed at the side surface of the frame 20 so as to be rotatable up and down. Although not shown, the upper face of the rotational member 142 has an insertion groove in which each of the lateral spraying nozzles 42 may be inserted.

The driving member 143 is a hydraulic cylinder which is operated by a fluid pressure, and one end of a piston rod is rotatably connected to the other end of the rotational member 142, and the other end of a piston is rotatably connected to the frame 20. Meanwhile, although not shown, unlike the embodiment, the driving member 143 may include a worm and a worm wheel, instead of the hydraulic cylinder.

The driving member 143 is connected to the control part 64 so as to be controlled by the control part 64. The control part 64 periodically rotates the rotational member 142 up and down so that the deicing agent may be uniformly sprayed to the road at the lateral side of the frame 20.

Further, when the distance from the side surfaces of the frame 20 to the edges of the road becomes wider than the initial distance, the control part 64 may rotate the rotational member 142 upwardly, and when the distance from the side surface of the frame 20 to the edge of the road becomes wider than the initial distance, the control part 64 may rotate the rotational member 142 downwardly.

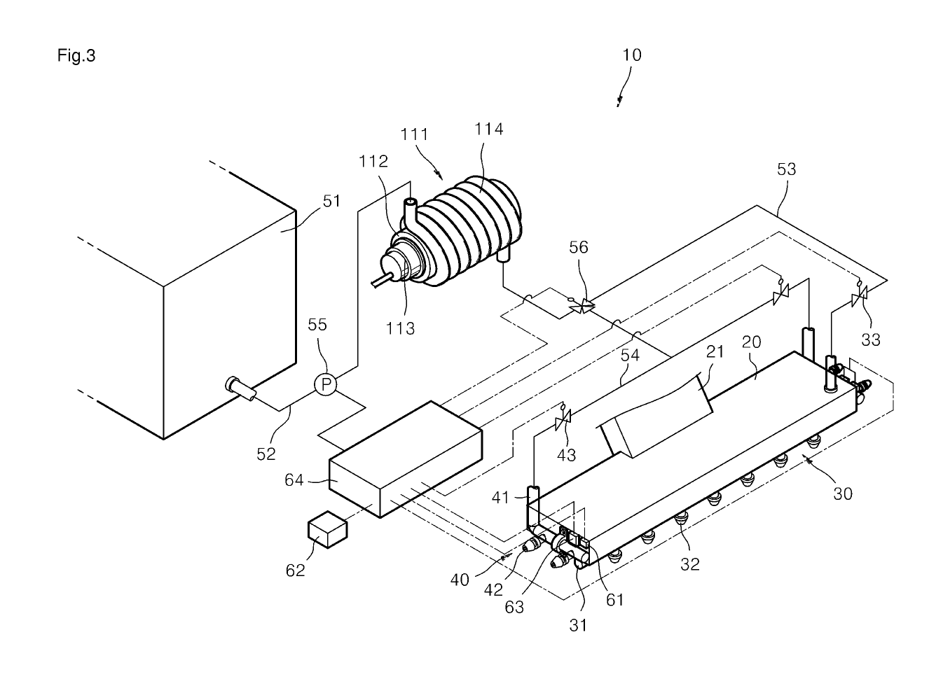

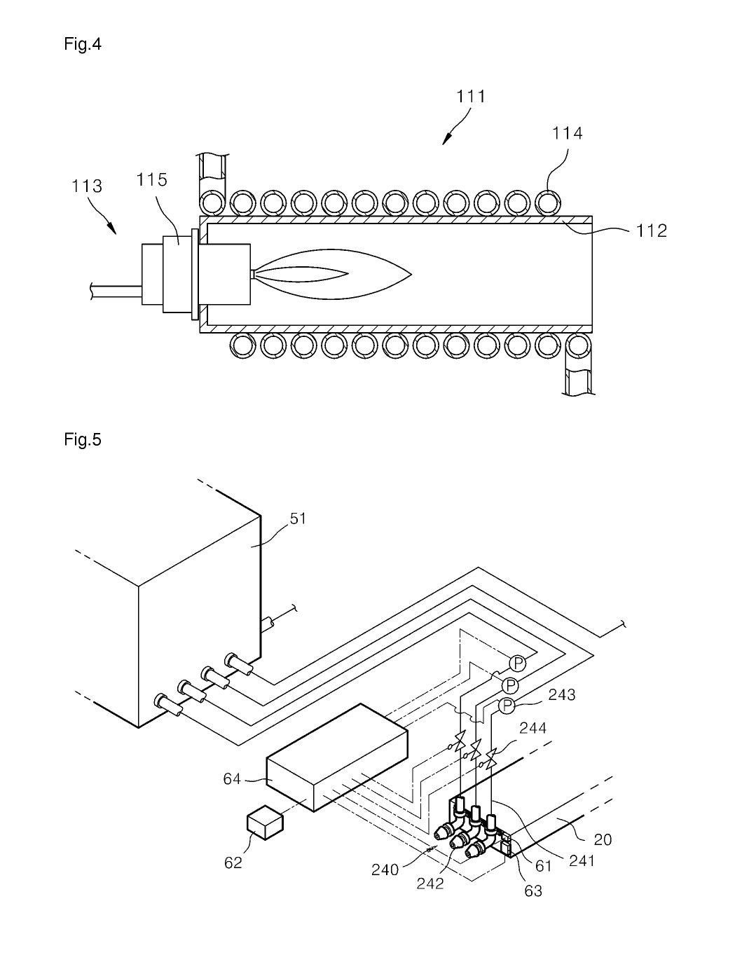

Meanwhile, FIGS. 3 and 4 illustrate a snow removing apparatus 110 for a vehicle according to still another embodiment of the present invention.

Referring to the drawings, the snow removing apparatus 110 for the vehicle further includes a deicing agent heating part 111 which heats the deicing agent flowing from the deicing agent supply part 50 to the first and second spraying parts 30 and 40.

The deicing agent heating part 111 is installed at the discharge tube 52 so as to heat the deicing agent, and includes a combustion container 112, a heating unit 113 installed in the combustion container 112, and a heat exchange tube 114 installed on an outer circumferential surface of the combustion container 112.

The combustion container 112 is formed into a cylindrical shape having an installation space therein. The combustion container 112 may be formed of steel or copper in order to easily transfer heat from the heating unit 113. One side of the combustion container 112 is opened so that combustion gas generated through a burner 115 of the heating unit 113 to be described below may be exhausted to an outside thereof.

The heating unit 113 includes the burner 115 installed at the installation space formed in the combustion container 112 so as to heat the combustion container 112, and a fuel supply member (not shown) supplying fuel to the burner 115.

The burner 115 is installed at the installation space of the combustion container 112 so as to combust the fuel supplied through the fuel supply member and to heat an inner circumferential surface of the combustion container 112.

The fuel supply member serves to supply combustible gas fuel, such as LPG, to the burner 115. Although not illustrated, the fuel supply member is installed at the vehicle, and includes a gas tank which stores huge amounts of the gas fuel, a gas supply tube which is installed to be connected with an outlet port of the gas tank and a fuel inlet port of the burner 115 and thus supply the gas fuel stored in the gas tank to the burner 115, and a gas valve which is installed at the gas supply tube so as to open and shut the gas supply tube. The heat exchange tube 114 is connected with the discharge tube 52, such that the deicing agent discharged from the storage tank 51 may pass therethrough. The heat exchange tube 114 has a passage through which the deicing agent flows. Further, the heat exchange tube 114 may be formed to be wound multiple times around an outer circumferential surface of the combustion container 112, such that the deicing agent flowing in the heat exchange tube 114 performs heat exchange with the combustion container 112.

As described above, since the heat exchange tube 114 is wound multiple times around the outer circumferential surface of the combustion container 112, a contact area with the outer circumferential surface of the combustion container 112 is increased and thus heat exchange efficiency with the combustion container 112 is enhanced.

In the snow removing apparatus 110 for the vehicle according to the present invention, since the deicing agent heated to a high temperature by the deicing agent heating part 111 is sprayed to the road, it is possible to enhance snow removing efficiency of the deicing agent.

Meanwhile, FIG. 5 is a perspective view of a second spraying part 240 according to yet still another embodiment of the present invention.

Referring to the drawing, one end of the second spraying part 240 is connected with the storage tank 51, and the other end thereof includes a plurality of third spraying tubes 241 which are respectively fixed to the both side surfaces of the frame 20, a plurality of lateral spraying nozzles 242 which are respectively to the other ends of the third spraying tubes 241 so as to spray the deicing agent to the lateral side of the frame 20, and a plurality of subsidiary pumps 243 which are respectively installed at the third spraying tubes 241 so as to pump and supply the deicing agent stored in the storage tank 51.

Three third spraying tubes 241 are installed at each of the both side surfaces of the frame 20, but the number of the third spraying tubes 241 are not limited thereto. The number of the third spraying tubes 241 may be two or more according to a width of the road. A 3-way opening and shutting valve 244 may be installed at each of the third spraying tubes 241 in order to open and shut a passage through which the deicing agent flows.

The lateral spraying nozzles 242 are respectively installed at the other end of the third spraying tubes 241, and spraying holes through which the deicing agent is sprayed are formed to be directed to the lateral side of the frame 20.

The subsidiary pumps 243 are respectively installed at the third spraying parts 241 so as to be controlled by the control part 64. The control part 64 controls each of the subsidiary pumps 243 so that the spraying pressure of each of the lateral spraying nozzles 242 may be different from each other.

Since each of the lateral spraying nozzles 242 installed at the both side surfaces of the frame 20 may spray the deicing agent with the different spraying pressure, the spraying range of the deicing agent is different, and the spraying range of the second spraying parts 240 may be increased, and also the deicing agent may be uniformly sprayed on the road.

Meanwhile, an operation state of the snow removing apparatus for the vehicle according to the present invention will be described fully.

First of all, in the snow removing apparatus for the vehicle of the present invention, the first and third opening and shutting valves 33 and 244 are opened by the control part 64, and thus the deicing agent may be sprayed to the lower and lateral sides of the frame 20 through the downward spraying nozzles 32 and the lateral spraying nozzles 242.

Further, an operator may operate the third opening and shutting valve 244 disposed at one of the both side surfaces of the frame 20 so as to shut the third spraying tubes 241 disposed at the one side surface, such that the deicing agent may be sprayed at only the other side surface of the frame 20.

And the operator may operate the third opening and shutting valve 244 disposed at one of the both side surfaces of the frame 20 so as to open the third spraying tubes 241 and may operate the first opening and shutting valve so as to shut the first spraying tube 31, such that the deicing agent may be sprayed at only the lateral side of the frame 20 through the lateral spraying nozzles 242.

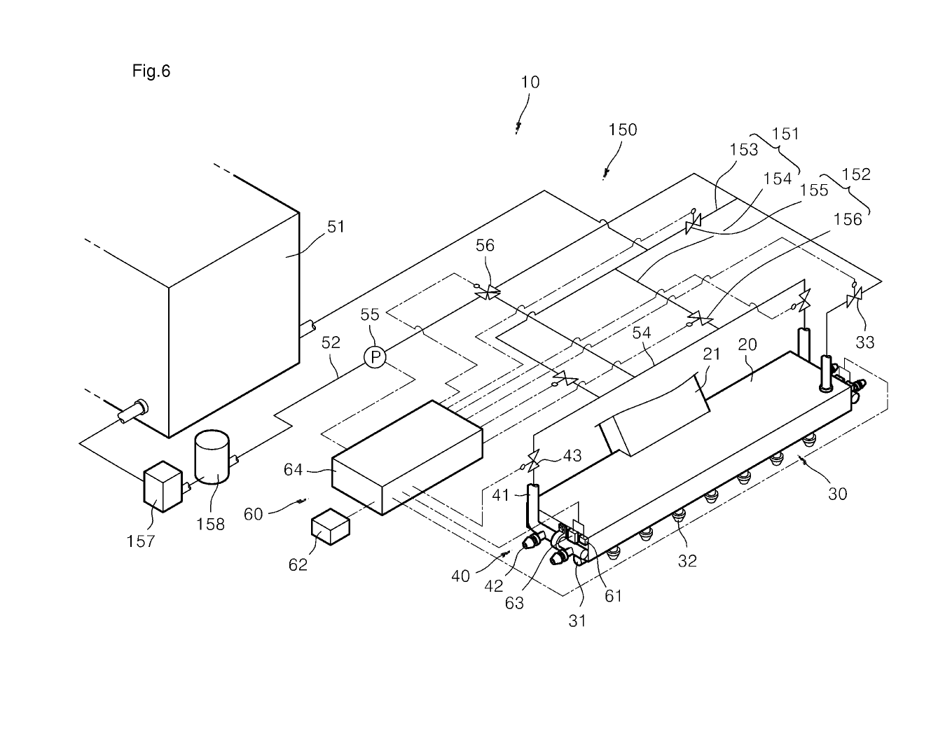

Meanwhile, FIG. 6 illustrates a snow removing apparatus for a vehicle according to yet still another embodiment of the present invention.

Referring to the drawing, a deicing agent supply part 150 includes a return conduit part 151 which has a plurality of tubes installed between the storage tank 51 and the first and second connection tubes 53 and 54, and a return valve part 152 which opens and shuts the tubes of the return conduit part 151.

The return conduit part 151 includes a first bypass tube 153 connected between the storage tank 51 and the first connection tube 53, and a second bypass tube 154 connected between the storage tank 51 and the second connection tube 54.

An end of the second bypass tube 154 is branched into two directions and connected with the second spraying tubes 41 of the second spraying part 40 installed at the both sides of the frame 20.

The return valve part 152 includes a first bypass valve 155 which is installed at the first bypass tube 153 so as to open and shut the first bypass tube 153, and a second bypass valve 156 which is installed at the second bypass tube 154 so as to open and shut the second bypass tube 154.

At this time, when the deicing agent is sprayed through the first and second spraying parts 30 and 40, the control part 64 controls the first and second bypass valves 155 and 156 so as to shut the first and second bypass tubes 153 and 154.

Meanwhile, when the first spraying tube 30 is shut by the first opening and shutting valve 33 so that the spraying of the deicing agent through the first spraying part 30 is stopped, the control part 64 controls the first bypass valve 155 so that the first connection tube 53 and the first bypass tube 153 are connected with each other and thus the deicing agent pumped by the supply pump 55 and introduced into the first connection tube 53 may be returned to the storage tank 51.

When the operation of the first spraying part 30 is stopped, the deicing agent introduced into the first connection tube 53 is returned to the storage tank 51. Therefore, even though a pumping pressure of the supply pump 55 is not controlled, the spraying pressure of the deicing agent sprayed through the second spraying part 40 is prevented from being suddenly increased.

Further, when the spraying of the deicing agent through the second spraying part 40 is stopped, the control part 64 controls the second bypass valve 156 so that the second connection tube 54 and the second bypass tube 154 are connected with each other and thus the deicing agent pumped by the supply pump 55 and introduced into the second connection tube 54 may be returned to the storage tank 51.

When the operation of the second spraying part 40 is stopped, the deicing agent introduced into the second connection tube 54 is returned to the storage tank 51. Therefore, even though the pumping pressure of the supply pump 55 is not controlled, the spraying pressure of the deicing agent sprayed through the first spraying part 30 is prevented from being suddenly increased.

Meanwhile, referring to FIG. 6, the deicing agent supply part 150 includes a boiler 158 and a subsidiary tank 157 installed at the discharge tube 52.

The subsidiary tank 157 has an internal space which may store the deicing agent therein, and the internal space may have a smaller volume than a storing space of the storage tank 51.

The boiler 158 is installed at a rear side of the subsidiary tank 157 based on a flowing direction of deicing agent so as to heat the deicing agent received in the subsidiary tank 157. As described above, since the subsidiary tank 157 has the smaller internal space than that of the storage tank 51, a less amount of the deicing agent may be rapidly heated by the boiler 158 and then supplied to the first and second spraying parts 30 and 40.

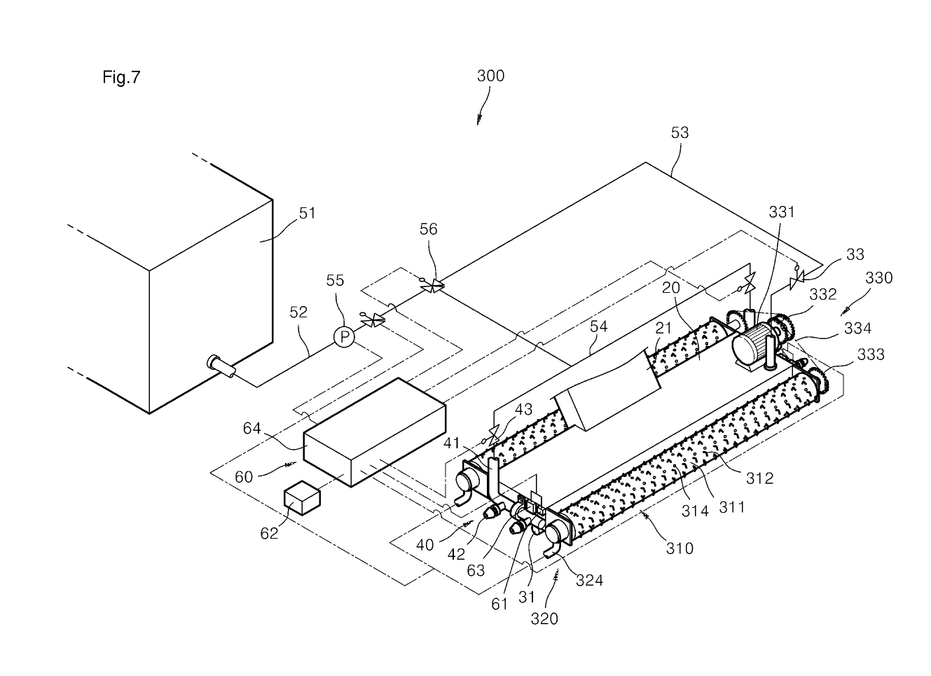

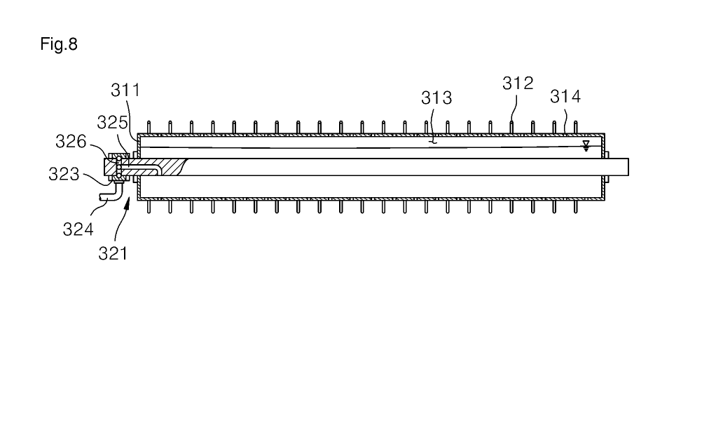

Meanwhile, FIGS. 7 and 8 illustrate a snow removing apparatus 300 for a vehicle according to yet still another embodiment of the present invention.

Referring to the drawings, the snow removing apparatus 300 for the vehicle further includes a crushing part 310 which crushes ice frozen on the road, and a third spraying part 320 which sprays the deicing agent on the road when the crushing part 310 crushes the ice.

The crushing part 310 includes a plurality of crushing rollers 311 which are respectively disposed at the frame so as to be spaced apart to the front and rear sides with respect to the first spraying part based on the vehicle movement direction, and a plurality of crushing blades 312 which are formed on an outer circumferential surface of each of the crushing rollers 311, a roller driving part 330 which rotates the crushing rollers 311.

Each of the crushing rollers 311 is formed into a cylindrical shape which is extended to be parallel with a width direction of the vehicle and which has a predetermined diameter. Each of the crushing rollers 311 has a rotational shaft of which both ends are rotatably supported to the frame.

The crushing blades 312 are respectively extended on the outer circumferential surface of each of the crushing rollers 311 in a direction away from each of the crushing rollers 311. An end of each of the crushing blades 312 may be formed to be bent in a rotational direction of each of the crushing rollers 311 in order to easily crush the ice frozen on the road.

The roller driving part 330 includes a rotational motor 331 which generates rotational force by electric power applied from an outside, a plurality of first sprockets 332 which are fastened to a driving shaft of the rotational motor 331, a plurality of second sprockets 333 which are fastened to one ends of rotational shafts of the crushing rollers 311, and a plurality of connection chains 334 which connect the first and second sprockets 332 and 333 with each other.

Meanwhile, in the drawings, the crushing rollers 311 are respectively installed at the front and rear sides with respect to the first spraying part 30. However, the crushing rollers 311 are not limited thereto. That is, the crushing rollers 311 may be installed at only one of the front and rear sides with respect to the first spraying part 30.

In the third spraying part 320, a chamber 313 in which the deicing agent is stored is provided in each of the crushing rollers 311, and a plurality of spraying holes 314 communicated with the chamber 313 are formed on the outer circumferential surface of each of the crushing rollers 311, and an injection passage 325 is formed to be communicated from the other end of the rotational shaft of each of the crushing rollers 311 into the chamber 313, and a plurality of rotary joints 321 which are rotatably installed at the other ends of the rotational shafts of the crushing rollers 311 so as to supply the deicing agent to the chamber 313.

At this time, grooves are formed in outer circumferential surfaces of the rotational shafts of the crushing rollers 311 so as to be connected with the injection passage 325 in a circumferential direction. Each of the rotary joints 321 includes a main body 323 which is rotatably installed at the other end of the rotational shaft of the crush roller 311, and a deicing agent supply tube 324 which is coupled to the main body 323 so as to supply the deicing agent to the chamber 313 through the groove 326 and the injection passage 325.

At this time, the deicing agent supply tube 324 is installed to be communicated with the discharge tube 52 so as to receive the deicing agent from the deicing supply part. A 3-way valve is installed at a portion in which the discharge tube 52 and the deicing agent supply tube 324 are connected. The 3-way valve is controlled by the control unit 60.

The deicing agent supplied from the deicing agent supply part 50 is introduced into the chamber 313 of the crush roller 311 through the rotary joint 321, and the introduced deicing agent is sprayed to the road through the spraying hole 314 by rotation of the crushing roller 311. As described above, the ice frozen on the road is crushed by the crushing part 310. While the crushing part 310 crushes the ice, the deicing agent is sprayed on the road, and thus the snow removing efficiency is enhanced.

Meanwhile, although not illustrated, the snow removing apparatus 300 for the vehicle may further include a lifting unit which lifts up and down the frame according to a thickness of the ice frozen on the road.

Although an exemplary embodiment of the present invention has been described in detail hereinabove, it should be understood that many variations and modifications of the basic inventive concept herein described, which may appear to those skilled in the art, will still fall within the spirit and scope of the exemplary embodiments of the present invention as defined by the appended claims.

What is claimed is:

1. A snow removing apparatus for a vehicle, comprising:
a frame installed at the vehicle;
a first spraying part installed at the frame so as to spray a deicing agent downwardly;
a second spraying part installed at at least one of both side surface of the frame so as to spray the deicing agent to a lateral side of the frame;
a deicing agent supply part supplying the deicing agent to the first and second spraying parts; and
a control unit controlling a deicing agent spraying state of the first and second spraying parts.

2. The snow removing apparatus of claim 1, wherein the control unit comprises a detecting sensor installed at the frame adjacent to the second spraying part so as to detect other vehicles or persons approaching a spraying range of the second spraying part; and a control part stopping a spraying operation of the deicing agent from the second spraying part when the other vehicles or persons are detected by the detecting sensor.

3. The snow removing apparatus of claim 2, wherein the control unit further comprises a speed sensor installed at the vehicle so as to detect a speed of the vehicle, and
the control part stops the spraying operation of the deicing agent through the first and second spraying parts when a stopped state of the vehicle is detected by the speed sensor.

4. The snow removing apparatus of claim 1, wherein the second spraying part comprises a rotational member which is installed at one of both side surfaces of the frame so as to be rotated up and down; at least one lateral spraying nozzle fixed to the rotational member so as to receive the deicing agent from the deicing agent supply part and to spray the deicing agent to a later side of the frame; and a driving member rotating the rotational member up and down.

5. The snow removing apparatus of claim 1, further comprising a deicing agent heating part heating the deicing agent flowing to the first and second spraying parts.

6. The snow removing apparatus of claim 1, wherein the deicing agent supply part comprises,
a storage tank in which the deicing agent is stored;
a supply conduit part comprising a first connection tube connected to the storage tank and the first spraying part so as to supply the deicing agent stored in the storage tank to the first spraying part, and a second connection tube connected to the storage tank and the second spraying part so as to supply the deicing agent stored in the storage tank to the second spraying part; and
a supply pump installed at the supply conduit part so as to pump and supply the deicing agent stored in the storage tank to the first and second spraying parts;
a return conduit part comprising a first bypass tube connected between the storage tank and the first connection tube, and the second bypass tube connected between the storage tank and the second connection tube; and
a return valve part comprising a first bypass valve installed at the first bypass tube so as to open and shut the first bypass tube, and a second bypass valve installed at the second bypass tube so as to open and shut the second bypass tube, and
when the spraying operation of the deicing agent through the first spraying part is stopped, the control part controls the first bypass valve so that the first connection tube and the first bypass tube are connected with each other and thus the deicing agent pumped by the supply pump and introduced into the first connection tube is returned to the storage tank, and when the spraying operation of the deicing agent through the second spraying part is stopped, the control part controls the second bypass valve so that the second connection tube and the second bypass tube are connected with each other and thus the deicing agent pumped by the supply pump and introduced into the second connection tube is returned to the storage tank,

7. The snow removing apparatus of claim 1, further comprising a crushing part installed at the frame so as to be spaced apart to the front and rear sides with respect to the first spraying part based on a vehicle movement direction and thus to crush ice frozen on a road; and a third spraying part spraying the deicing agent to the road when the crushing part crushes the ice.

8. The snow removing apparatus of claim 7, wherein the crushing part comprises a crushing roller of which both ends are rotatably installed at the frame; a plurality of crushing blades which are formed on an outer circumferential surface of the crushing roller so as to protrude in a direction away from the crushing roller; and a roller driving part which rotates the crushing roller.

9. The snow removing apparatus of claim 8, wherein the third spraying part comprises a chamber provided in the crushing roller so as to store the deicing agent, a plurality of spraying holes formed in the outer circumferential surface of the crushing roller so as to be communicated with the chamber, an injection passage formed to be communicated from a rotational shaft of the crushing roller into the chamber, and a rotary joint rotatably installed at the rotational shaft of the crushing roller so as to supply the deicing agent to the chamber, and
the deicing agent supply part supplies the deicing agent to the chamber through the rotary joint.
